(19) United States
(12) Patent Application Publication
(10) Pub. No.: US 2011/0050546 A1
(43) Pub. Date: Mar. 3, 2011

(54) EYEWEAR FOR PEOPLE WITH LOW VISION OR IMPAIRED VISION

(76) Inventors: Peter John Swartz, JR., Homosassa, FL (US); Stanley David Swartz, Lake City, FL (US); Martin Allen Swartz, Navarre, FL (US); Janet Elizabeth Swartz, Homosassa, FL (US)

(21) Appl. No.: 12/550,359

(22) Filed: Aug. 29, 2009

(51) Int. Cl. G09G 5/00; G02C 5/00; G02C 1/00

(52) U.S. Cl. 345/8; 351/41; 351/158

(57) ABSTRACT

The device is eyewear that aids people with low or impaired vision. The eyewear consists of miniature cameras and thin-film transistor (TFT) screens which are powered by a portable battery pack. These items (cameras and TFTs) are imbedded into the eyewear frames. The person with low or impaired vision wears the eyewear like regular eyeglasses, the cameras collect the images, and the TFTs display them in a manner in which the person can easily view the images in a light controlled environment. The eyewear is portable and can be folded like regular eyeglasses.

1. Although there are many devices on the market today that incorporate the use of embedded electronics for viewing video information from sources such as DVD, MP3, or CAMERA outputs, and consumers have a wide choice of design features such as night vision wear and infrared capabilities for various applications, this eyewear is specifically targeted to people who live with impaired vision.

2. Low or impaired vision can be defined as a condition that occurs from a variety of vision disorder such as, but not limited to, Retinitis Pigmentosa (RP), Macular Degeneration, Stroke and normal Age related conditions. The unique design of the Eyewear frame and the manipulation of the electronics embedded in the frame, allow the wearer to enjoy an enhanced quality of life in environments that would normally cause them difficulty if such a device were not worn.

### SUMMARY OF INVENTION

1. The uniqueness of the eyewear occurs by design of a frame that prevents the wearer from having any intrusions of exterior influence on the eye such as bright sunlight. People with low vision, bright sunlight or other above mentioned conditions could cause difficulties in total vision or clarity of vision and function. The frame is so designed as to rest snugly on the wearers face in such a manner that the eye is isolated in a constant light controlled environment. The eyewear is designed to appear as a slightly oversized pair of normal sunglasses with sufficient room behind the front shield to house the electronics. The outside appearance of the front of the eyewear is made to look like dark sunglasses, but of such a material as to prevent or minimize any intrusion of light.

2. The construction of the frame is of such material as to insure a lightweight comfortable wearing experience. Where possible, carbon fiber or high strength plastic construction is employed for both weight and durability.

3. The electronics of the device will be embedded primarily behind the front shield of the frame. Future version may have the components located in a different location in hopes to reduce the size and weight of the product. The unique use of multiple cameras will serve in both allowing the wearer to see as close to normal forward vision as possible with one camera and being able to switch to another camera for dose viewing, such as for reading normal printed material, playing cards and table games, or other close in functions.

4. The use of lenses with various focal lengths can be incorporated to meet the needs of the individual wearer. Since low vision applications can vary from person to person, this can give a greater choice to each individual wearer to meet a specific need.

5. Simplification of design is essential to assure the user has ease of operation. Three control points will be incorporated in the design. They are, ON/OFF, BRIGHTNESS CONTOL and CAMERA SELECTION. Controls will be easily identified by feel and location. Note: Future designs may contain additional user controls to adjust contrast, resolution, sharpness, etc.

6. The wearer will have the ability to choose which camera they wish to use for viewing. This is accomplished by use of a simple switch. For example, one camera is positioned to view straight forward on the horizontal plane for normal functions such as walking or engaging in social functions. Another camera may be used for reading and is of a closer focal length. This camera is tilted slightly downward for easy viewing, of printed material on a table, desk or on the wearers lap. This is also important, as the wearer will not have to bend the head too far downward in a position not normally used for reading. A third camera might be added for use in very low light applications (getting up in the middle of the night) with the addition of infrared lighting.

7. The wearer will view the camera images on high-resolution TFT (thin film transistors) modules embedded on the inside back surface of the eyewear front shield. A lens constructed in the frame of the eyewear will make it possible for the wearer to see a large clear image of what is transferred by the camera to the TFT screens. All electronic components will be covered by an inside component protection cover. Space in the component protection cover will hold the viewing lens.

8. Power will be supplied by a rechargeable battery pack connected by wires attached through the back end of one of the frame's earpiece.

9. The use of high-resolution CCD (charged coupled device) cameras is essential in the construction of the eyewear. Because of their ability to display high quality images in very low-lit conditions, this gives a person with low or impaired vision a great advantage, which previously was not available to them. For many people with low or impaired vision, a darkened environment is their greatest challenge. With the evolution of high quality, lightweight electronic components, it is now possible for people with low or impaired vision to see objects in environments that were once difficult or impossible for them to see.

10. The design of the binocular effect of this eyewear is also a great tool for people with low or impaired vision. It has been demonstrated that even severally damaged vision due to stroke, the brain has the ability to assemble the transferred camera image information into a single image easily understood by the viewer. With this eyewear, the wearer will experience a much enhanced quality of life.

### BRIEF DESCRIPTION OF DRAWINGS

FIG. 1—Is a front view of the eyewear frame.

FIG. 2—Is a rear view of the eyewear frame as illustrated in the drawing of FIG. 1.

FIG. 3—Is a schematic showing the location of the electronic components within the frame.

FIG. 4—Is a drawing of the TFT (thin film transistor) and viewing lens arrangement supported by a human head.

FIG. 5—Is a top view of the viewing lens and TFT (thin film transistor) modules.

FIG. 6—Is a side view of the high-resolution CCD cameras mounted on the eyewear shield.

FIG. 7—Is a drawing of the inner frame electronic protection cover.

FIG. 8—Is a schematic drawing of the electronic component parts.

### DETAILED DISCRIPTION OF THE INVENTION

In the following description of the embodiments of this device, we will show that (as of now) the invention has a single purpose (but not limited to future purposes) and that is being an aid to people with low or impaired vision. By description, low or impaired vision is a condition suffered by a large percentage of any population and can range from mild to severe, which may eventually lead to the total loss of sight. For our purposes, this can include people with NIGHT BLINDNESS, TUNNEL VISION, Retinitis Pigmentosa (RP), MAGULAR DEGENERATION, and STROKE, just to name a few. In our studies conducted on people with the above conditions, we have demonstrated a person with NIGHT BLINDNESS, as a result of RP, had a remarkable increase in vision when wearing our eyewear. An example would be a difficult time going from brightly lit environment to a darkened environment, such as a restaurant or church, without the aid of another person. We have demonstrated that with this eyewear, they can now make the transition with ease. With victims of STROKE, where part of the vision was damage, we have demonstrated that vision restoration has occurred and a task such as reading is possible. Two very important factors in the design of this eyewear are:
(a) Enclose wearer's eyes in an isolated environment with the absence of outside light
(b) Create a lightweight construction.

This invention and its design are concluded from results of studies on individuals with RP, STROKE and LOW VISION combined with personal first hand knowledge of the needs of individuals with low vision problems. Careful detail has been given to the device in:
(a) Appearance
   Note: Other than being slightly larger than a standard pair of sunglasses, the wearer should have no attention brought to them by wearing this device
(b) Operation
   Note: The combination of screen sizes and lenses, power, and mounting location makes this eyewear very customizable. Striking a balance between function and cost is key to user satisfaction.
(c) Comfort
   Note: One important characteristics of the device is its lightweight. This will allow the wearer to wear the eyewear for a longer period of time.

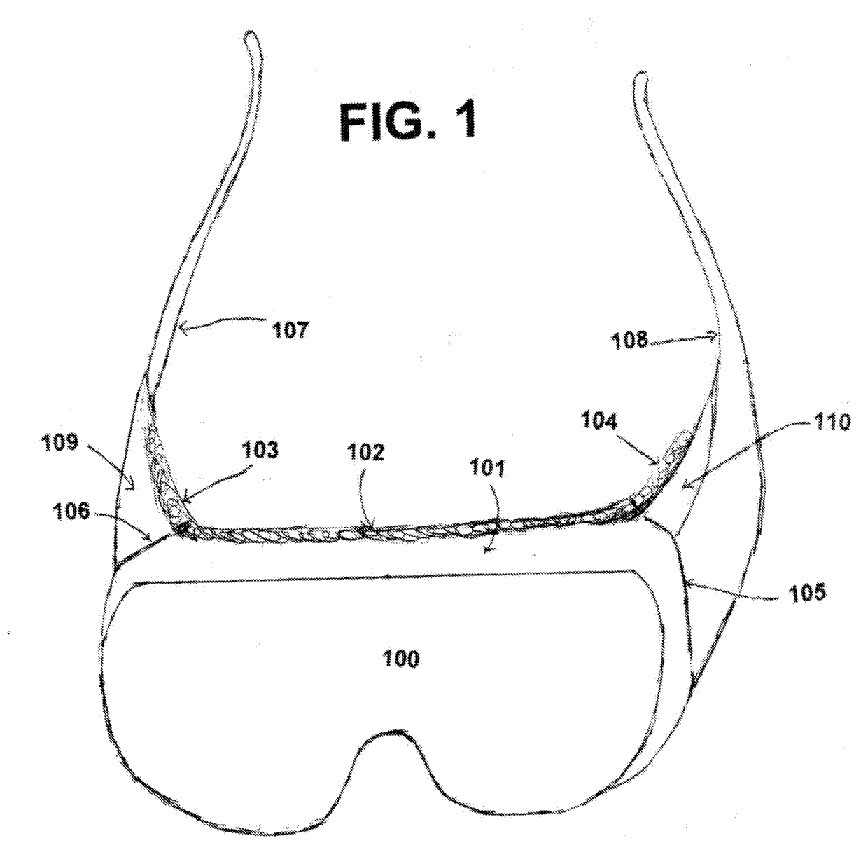

FIG. 1 Shows the front view of the eyewear. The front shield 100 is straight, not curved (other designs could be curved as the product evolves). Along with a deeper top cover 101 and temple pieces 107, 108 deeper top cover 109, 110. This allows sufficient room behind front shield 100 for easy mounting of the electronic components. Temple pieces 107 and 108 are wide in the vertical direction by design to eliminate intrusion of outside light. A lightweight soft padding 102, 103, and 104 is attached to the inside outer rim of the frame to rest snugly against the wearers forehead. This design feature is used to eliminate the intrusion of outside light. Wherever possible, carbon fiber or high strength plastics will be used as a lightweight construction material. The hinge 105 and 106 of temple piece 107 and 108 allow the eyewear to fold for easy storage.

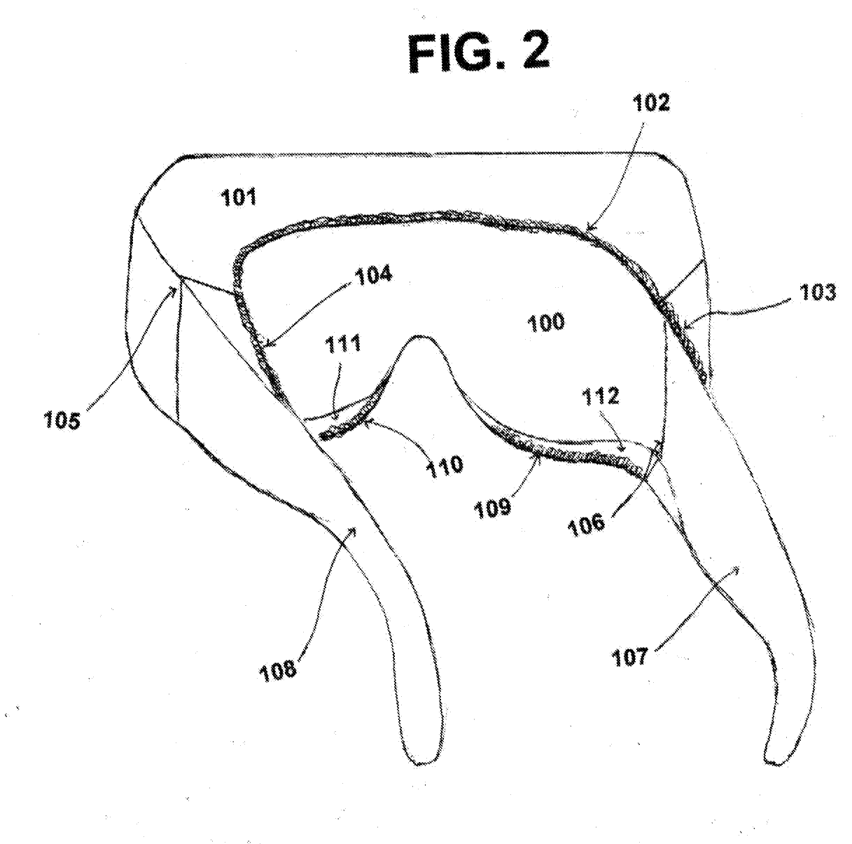

FIG. 2 Shows the inside rear view of the eyewear. The bottom cover 111 is attached to the bottom of the front shield 100 that is to the left of the nose bridge and the bottom cover 112 is attached to the front of the shield 100 that is to the right of the nose bridge. They are deep by design to allow room for mounting of the electronic components. A lightweight soft padding 109, and 110 is attached to the inside outer rim to snugly fit the frame to the cheek of the wearer. This design feature is not only for wearer comfort, but is also used to eliminate the intrusion of outside light.

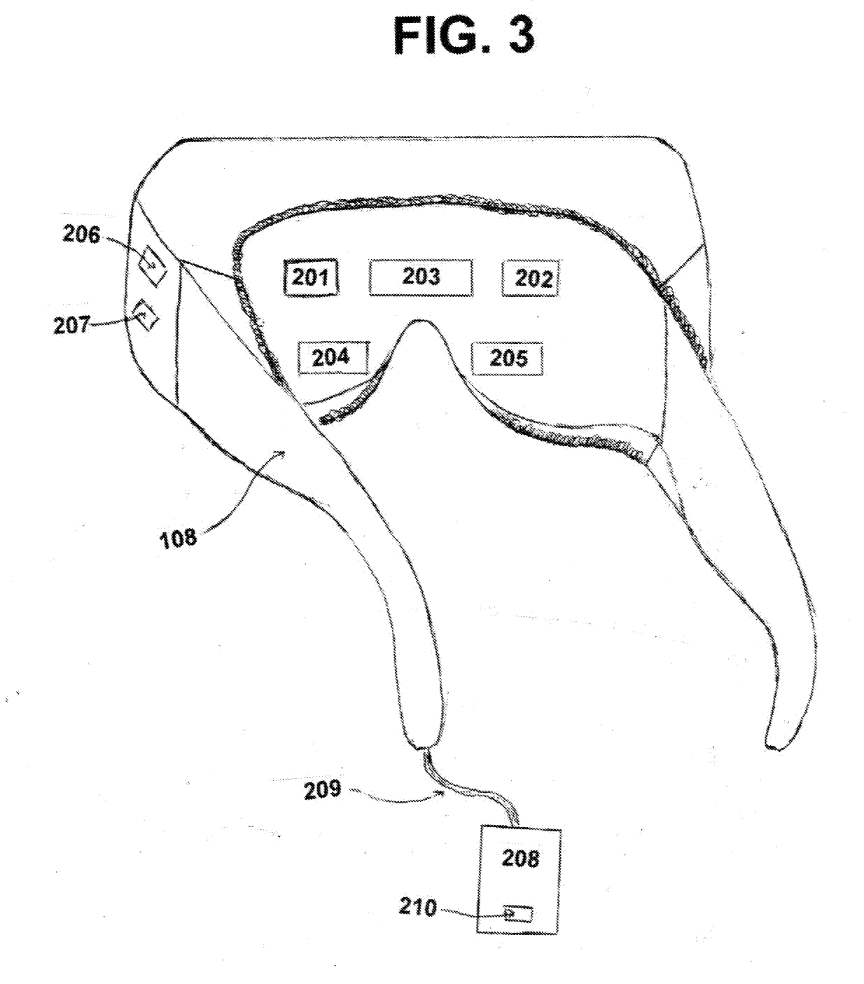

FIG. 3 Is a rear inside view of the eyewear frame, which shows the placement of the electronic components. All electronic components, 201, 202, 203, 204 and 205 are mounted on the inside rear shield 100 of the frame. Two (or more) additional control components 206 and 207 are mounted to temple earpiece 108 (but could be mounted someplace else as the device evolves). 201 are a TFT (thin film transistor) module for viewing with the left eye of the wearer while 202 is a TFT module for viewing with the right eye of the wearer. The placement of 201 TFT module and 202 TFT are aligned to give a binocular effect so the wearer sees only a single image. The TFT module 201 and 202 are fed information by integrated circuit driver electronic component, and are comprised of a small circuit board 203 mounted above the nose bridge of the rear of shield 100. A high resolution CCD camera 204 is mounted on the lower portion and to the left side of the nose bridge on the rear of shield 100. Camera 204 is positioned as to look forward or in the horizontal direction for viewing forward and side-to-side. A high resolution CCD camera 205 is mounted on the lower right portion of the rear of shield 100 to the right of the nose bridge. Camera 205 is mounted at a downward angle for viewing objects such as normal printed material by the wearer. (Note: In other designs additional cameras may be incorporated as this device evolves and improves.) Cameras 204 and 205 can be selected for individual viewing by a switch 206 mounted in the left temple earpiece 108. An additional control 207 is for controlling the brightness on TFT module 201 and 202. (Note: Other designs may contain additional user controls to adjust contrast, resolution, sharpness, etc.) A wire harness 209 feeds power to the components through the rearward portion of temple earpiece 108 and is connected to a rechargeable battery pack 208. A power switch (ON/OFF) 210 is embedded in the case of battery pack 208 for disconnected power to the eyewear.

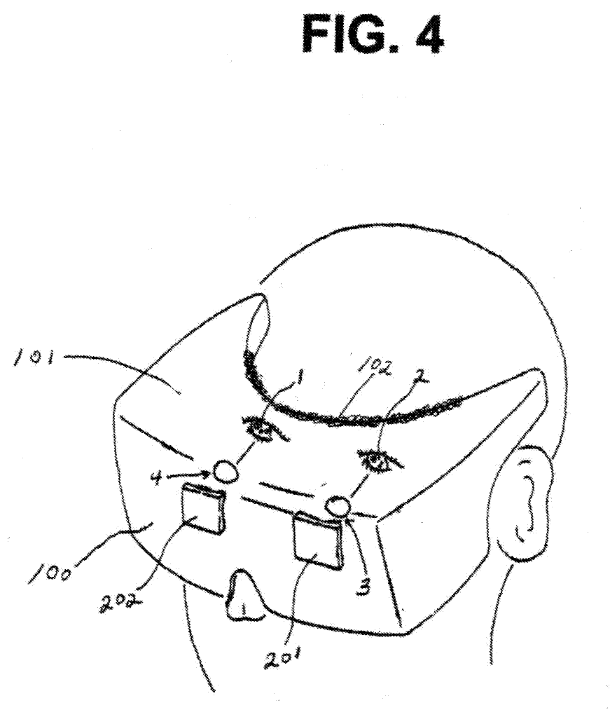

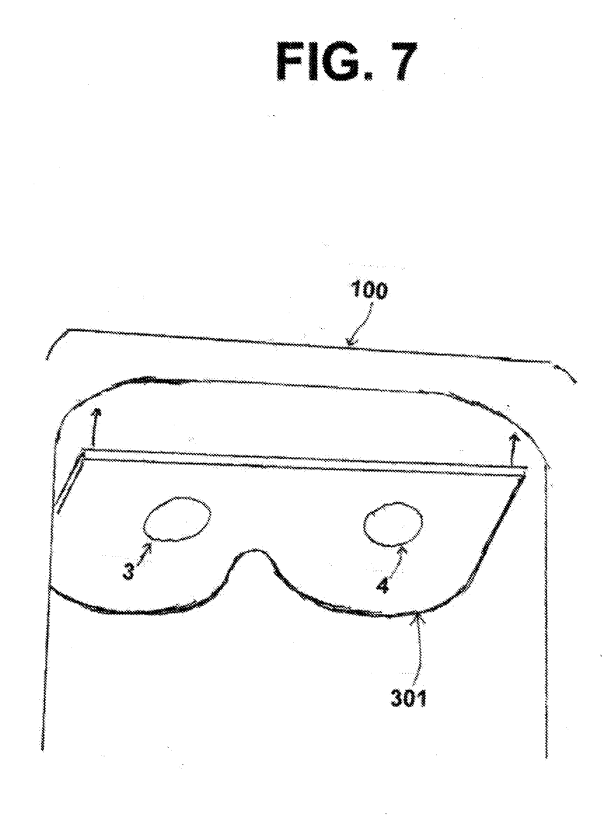

FIG. 4 Is a drawing of a human head with the eyewear on the face. This drawing is over exaggerated for the purpose of clarity. This is a transparent view of the eyewear to show the placement of the TFT (thin film transistor) module 201 for the left eye 2, mounted on the rear of eyewear shield 100 and the placement of the TFT module 202 for the right eye (1), mounted on the rear of the eyewear shield 100. Eyepiece lens 3 is mounted as to focus on TFT module 201 left eye 2, and eyepiece lens 4, is mounted as to focus on TFT module 202 right eye 1. Lens 3 and 4 are mounted on an inner component protection cover 301 described in FIG. 7. Soft padding 102 is placed on the outer edge of the rim of top cover 101 as to snugly rest against the forehead of the wearer. This is to prevent the intrusion of outside bright light for entering inside the eyewear.

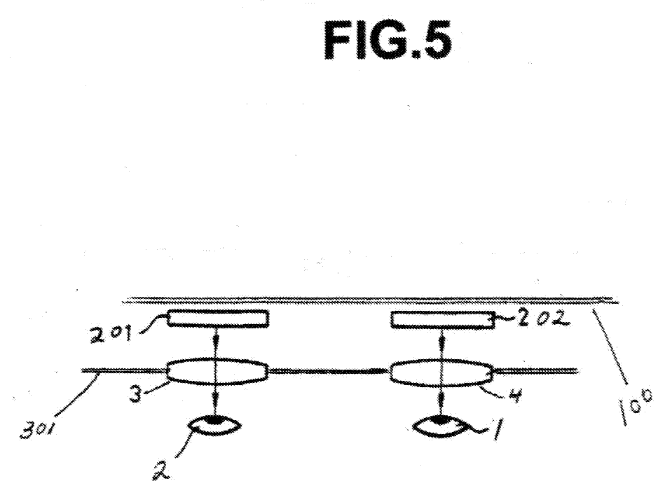

FIG. 5 Is a drawing showing the placement of the TFT (thin film transistor) module, their associated lenses and the viewers eyes. TFT module 201 for the left eye 2, and TFT module 202 for the right eye 1 are mounted to the frames shield 100 on the rear of the eyewear. Viewing lens 3 for the left eye and viewing lens 4 for the right eye are mounted on the electronics protection cover 301 that is fastened to the inside and to the rear of eyewear shield 100. Viewers left eye 2 is focused on TFT module 201 and viewer's right eye 1 is focused on TFT module 202. The horizontal spacing of TFT module 201 left eye and TFT module 202 right eye, give a binocular effect that allows the viewer to see a single image.

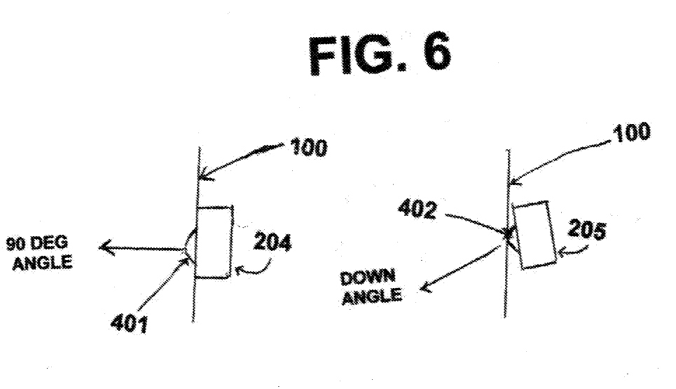

FIG. 6 Shows the mounting of the high-resolution CCD cameras 204 and 205 to the rear of frame shield 100. High resolution CCD camera 204 is mounted so as to see straight forward on the horizontal plane. This allows the wearer to see in a straight line to easily identify objects in front or side-to-side. Camera lens 401 sees through a pinhole drilled into frame shield 100. Camera lens 401 can be selected at various focal lengths to meet the needs of a specific wearer. For normal vision, a focal length of lens 401 may be 3.6 mm to 4.7 mm. A high resolution CCD camera 205 is mounted so as to see in a tilted downward direction. This allows the viewer to see objects such as printed material in a normal reading position without having to tilt the head in an uncomfortable downward position. Camera lens 402 sees through a pinhole drilled into frame shield 100. Camera lens 402 can be selected so as to bring objects such as printed material into closer view. For this purpose a lens with a focal length of 6 mm to 8 mm can be used depending on users' preference. When using the eyewear, the wearer has the option of choosing either high resolution CCD camera 204 or 205 depending on their immediate needs (other models may offer other camera options users may choose from). The selection of the camera is accomplished by changing camera switch 206 to the specific camera position.

FIG. 7 Is a drawing showing the component protection cover 301 of the eyewear. Viewing lens 3 for the wearers left eye and viewing lens 4 for the wearers right eye are mounted in the component protection cover 301. Component protection cover 301 is fastened to the rear of frame shield 100 in such a way that the correct focal length for lens 3 right eye and lens 4 left eye is achieved to view a clear focused image on TFT (thin film transistor) module 201 left eye and TFT module 202 right eye.

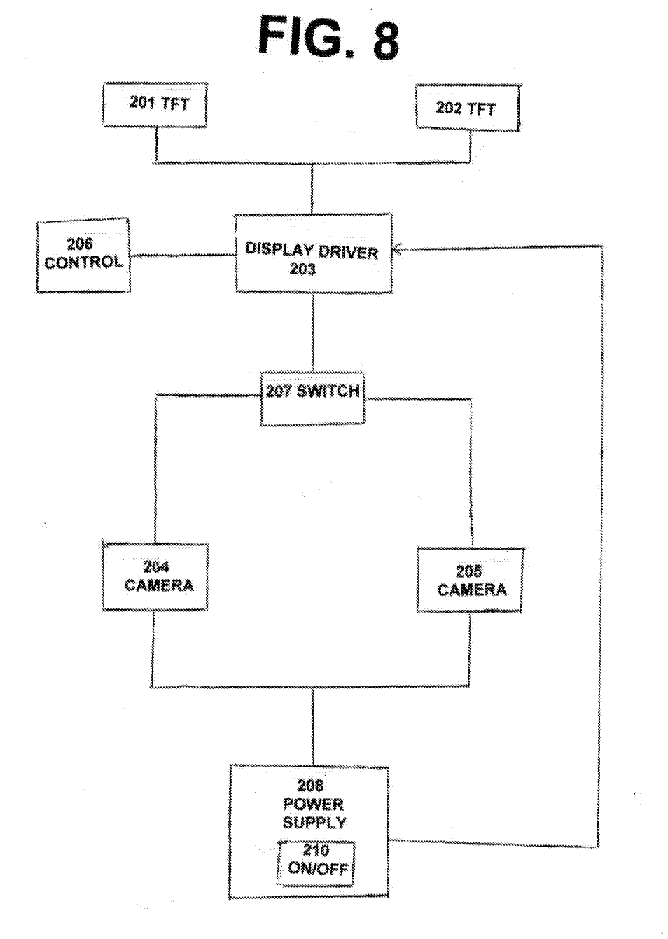

FIG. 8 Is a schematic drawing of the electronic components of the eyewear. All components, 201, 202, 203, 204, 205, 206 and 207 are embedded into the eyewear. Power supply 208 is attached by wire (209 not shown) through the rearward part of temple earpiece 108 and supplies power to the electronics. In the schematic, 201 is the TFT (thin film transistor) module for the left eye. 202 is the TFT module for the right eye. Display Driver 203 processes the high-resolution CCD camera outputs for viewing. Brightness Control 206 varies the brightness of TFT module 201 and TFT module 202. Switch 207 selects which camera will be viewed. Where high resolution CCD camera 204 is for viewing objects in the horizontal plane or side-to-side, high resolution CCD camera 205 is for viewing objects closer, such as normal printed material. Power supply 208 is a rechargeable power supply to feed power to the electronics. Switch 210 is embedded in the power supply and switches the power on and off to the electronics.

What is claimed is:

1. An eyewear comprising a frame consisting of a front portion shield made in one piece and right and left ear stems extending rearward from the frame and hinged at the rear of the shield as to fold inward toward the rear of the shield. The right ear stem folding to the left and left ear stem folding to the right and coming to rest at the rear of the shield for easy storage.

2. The eyewear according to claim 1 having a front shield molded from a single piece of lightweight material, fashioned to appear as dark sunglasses and that the front shield of the eyewear is non transparent as to not allow intrusion of exterior light into the frame.

3. That the front shield of claim 1 is fashioned with a deep top cover and deep bottom cover allowing space behind the front shield to allow for the mounting of electronic components.

4. That the deep top rear portion of the cover of the shield, according to claim 3 is slightly curved to contour to the forehead of the wearer.

5. That the rear outside rim of the deep top cover of the shield of claim 3 is fitted with a soft cushion material as to fit snugly on the wearers forehead to prevent the intrusion of exterior light.

6. That the bottom of the front shield of the eyewear of claim 1 is fashioned with a deep bottom cover. The bottom cover on the left side of the shield extends from the bottom of the left hinge of the shield to the bottom of the left side of the nose bridge. That the bottom cover on the right side of the shield extends from the bottom of the right hinge of the shield to the right side of the bottom of the nose bridge.

7. That the deep bottom covers of the shield according to claim 1 is slightly curved to contour to the cheek of the wearer.

8. That the rear outer rim of the deep bottom covers of the shield of claim 6 is fitted with a soft cushion material as to fit snugly on the wearer's cheek to prevent the intrusion of exterior light.

9. That the ear stems of claim 1 are wide from top to bottom in the vertical axis at the hinge of the shield and tapers slowly towards the ears. This is to prevent the intrusion of exterior light into the rear of the shield

10. Electronic components are mounted according to claim 3 behind the front shield of the eyewear. These components and the arrangements of which are design to bring functionality to the eyewear. They consist of two TFT (thin film transistor) modules. One TFT module positioned for left eye viewing and one TFT module positioned for right eye viewing. A Display driver board is mounted above the nose bridge on the rear of the shield. Two high-resolution color CCD cameras are mounted on the rear of the shield. One high resolution CCD color camera is mounted on the lower left of the rear of the front shield to the left of the nose bridge and one high resolution CCD color camera is mounted on the lower right of the rear of the front shield to the right of the nose bridge.

11. The TFT (thin film transistor) modules of claim 10 are high resolution Thin Film Transistors and are used for view camera images of cameras in claim 10 that are processed by the Display driver of claim 10. These two TFT module modules are mounted on the rear of front shield claim 3 and are positioned, one TFT module on upper left and one TFT module on the upper right of claim 10 of the rear of front shield claim 3. The TFT module on the left is for viewing by the wearers left eye. The TFT module on the right is for viewing by the wearer's right eye. The left and right TFT modules are spaced horizontally as to create a binocular effect so the viewer sees a single image. A pair of optical lens is used to allow the viewer a clear large image of the TFT modules. The lenses are mounted to a rear component protection cover that attaches on the rear of the shield claim 3. The component protection cover is distanced from the TFT modules to create a proper focal length for viewing.

12. According to claim 10, two high-resolution CCD color cameras are mounted on the rear of the front shield of claim 3. One high resolution CCD color camera is mounted on the lower left side of the rear of the front shield claim 10. This camera is mounted as to look forward in the horizontal plane for viewing objects in front or from side-to-side of the wearer as the head is turned in either direction. The lens for this camera can vary in focal length according to user preference. Normal viewing would require a lens with a focal length of 3.6 mm to 4.7 mm. The camera would see through a pinhole drilled in the front shield of claim 1. A second high resolution CCD color camera is mounted on the lower right claim 10 of the rear of front shield of claim 10. This camera is mounted as to look down on an angle for viewing objects such as printed material or playing games such as cards. Viewing with this camera would allow objects brought closer and would require a lens with a focal length of 6 mm to 8 mm. This would be according to user preference. Note: The opportunity to have more than two cameras installed is an option that will bring further enhancements to this product as it evolves.

13. According to claim 11, two high resolution TFT (thin film transistor) modules are mounted on the rear shield according to claim 3. To control the brightness of the TFT modules, a control is mounted on the forward left ear stem of claim 1. This control is wired into the display driver board mounted on the rear of the front shield according to claim 10.

14. According to claim 12, two high-resolution CCD color cameras are mounted on the rear of front shield according to claim 10. Each camera has a different function in that the camera mounted on the left side of the rear of the front shield claim 12 is for viewing objects in the forward horizontal plane and from side to side and that the camera mounted on the right side of the rear of the front shield claim 12 is for viewing objects at a downward angle and zoomed in, it is necessary to be able to select each camera individually. This is accomplished through the use of a simple switch that selects which camera output to send to the display driver board of claim 10. This switch is mounted on the forward left ear stem of daim 1. This switch is wired into the display driver board mounted on the rear of the front shield according to claim 10. Note: The use of multiple cameras increases the functionality of the eyewear.

15. According to daim 10.To supply power to all the electronics, a rechargeable battery pack with a power ON/OFF switch embedded it its case is connected to the eyewear. This is accomplished by attaching a cable that runs through the rearward end of the left ear stem claim 1. This cable is embedded within the ear stem and exits at the forward end of the ear stem. From there it is connected to the electronics. According to claim 11, an electronic component protection cover is fastened to the rear of the front shield claim 3. This cover also contains the optical viewing lens.
